(19) United States
(12) Patent Application Publication
(10) Pub. No.: US 2008/0130163 A1
(43) Pub. Date: Jun. 5, 2008

(54) Magnetic Recording/Reproducing Apparatus and Tape-Pulling-Out Element Thereof

(75) Inventors: Takumi Nishimura, Ehime (JP); Takashi Kimura, Ehime (JP)

Correspondence Address: KRATZ, QUINTOS & HANSON, LLP, 1420 K Street, N.W., Suite 400, WASHINGTON, DC, 20005, US

(73) Assignee: MATSUSHITA ELECTRIC INDUSTRIAL CO., LTD., Kadoma-shi (JP)

(21) Appl. No.: 11/662,732

(22) PCT Filed: Sep. 8, 2005
(86) PCT No.: PCT/JP2005/016522

§ 371 Date: Oct. 4, 2007

(30) Foreign Application Priority Data
Sep. 14, 2004 (JP) 2004-266260

(51) Int. Cl. G11B 5/027

(52) U.S. Cl. 360/85

(57) ABSTRACT

It is an object of the present invention to provide a magnetic recording/reproducing apparatus and its tape-pulling-out element capable of reliably holding a coupling element and stably carrying out tape threading. In a magnetic recording/reproducing apparatus, an end of a tape accommodated in a tape cassette 2 has a coupling element 8, the coupling element 8 is pulled out and the tape is taken up around a drive reel. The magnetic recording/reproducing apparatus comprises a leader tape 41 having one end connected to the drive reel, a tape-pulling-out element 40 connected to the other end of the leader tape 41, and a pulling-out element moving motor 51 for moving the tape-pulling-out element 40 into the tape cassette 2. The tape-pulling-out element 40 includes a first member 42 formed with a recess 42A, and a second member 43 connected to the first member 42 such that the second member 43 can be displaced, and the coupling element 8 is mounted on the tape-pulling-out element 40 by the recess and the second member 43.

### TECHNICAL FIELD

The present invention relates to a magnetic recording/reproducing apparatus which pulls out an end of a tape from a tape cassette of a single hub having one reel around which a tape is wound, and which winds the tape around a drive reel, and which carries out recording and replaying operations, and the invention also relates to a tape-pulling-out element thereof.

### BACKGROUND TECHNIQUE

In a conventional magnetic recording/reproducing apparatus of this kind, in order to pull out a coupling element provided on an end of a magnetic tape in a tape cassette, a coupling element pulling out member is provided with a pair of hook mechanism on which the coupling element is hooked. Both ends of the coupling element are hooked on the pair of hook mechanisms, and a central portion of the coupling element is pressed by another member, thereby holding the coupling element (e.g., patent document 1).

[Patent Document 1]

Japanese Patent Application Laid-open No. 2002-530794 (paragraph number (0046), FIG. 6)

According to the conventional apparatus, the tape is held by the hook mechanisms and the pressing member, the coupling element is released by an external force from an unexpected direction or is inclined, and a threading operation of the magnetic tape can not be carried out stably.

It is an object of the present invention to provide a magnetic recording/reproducing apparatus and a tape-pulling-out element capable of reliably holding the coupling element and stably carrying out the tape threading operation.

### DISCLOSURE OF THE INVENTION

A first aspect of the present invention provides a magnetic recording/reproducing apparatus in which an end of a tape accommodated in a tape cassette has a coupling element, the coupling element is pulled out and the tape is taken up around a drive reel, the magnetic recording/reproducing apparatus comprising a leader tape having one end connected to the drive reel, a tape-pulling-out element connected to the other end of the leader tape, and a pulling-out element moving motor for moving the tape-pulling-out element into the tape cassette, wherein the tape-pulling-out element includes a first member formed with a recess, and a second member connected to the first member such that the second member can be displaced, and the coupling element is mounted on the tape-pulling-out element by the recess and the second member.

According to a second aspect of the invention, in the first aspect, the coupling element comprises a shaft portion and enlarged portions formed on opposite ends of the shaft portion, and at least the opposite ends of the shaft portion are covered with the recess and the second member.

According to a third aspect of the invention, in the first aspect, the second member is formed with a recess, and the coupling element is mounted between the recess of the first member and the recess of the second member.

According to a fourth aspect of the invention, in the first aspect, the first member is provided at its one end with a turn shaft which turns the second member, the first member is provided at its other end with the recess.

According to a fifth aspect of the invention, in the fourth aspect, magnetic recording/reproducing apparatus further comprises a track groove for guiding the tape-pulling-out element to the drive reel, and an end of the turn shaft slides in the track groove.

According to a sixth aspect of the invention, in the fourth aspect, the recess of the first member is opened by pressing the second member on the side of the turn shaft.

According to a seventh aspect of the invention, in the fifth aspect, the magnetic recording/reproducing apparatus further comprises a tape-pulling-out element moving member which holds the tape-pulling-out element and which is moved by rotation of the pulling-out element moving motor, and the tape-pulling-out element moving member includes a turning shaft recess with which the turn shaft is engaged, and the turning shaft recess is disposed at a position where the turning shaft recess is continuous with the track groove when take-up operation by the drive reel is started.

An eighth aspect of the invention provides a tape-pulling-out element of a magnetic recording/reproducing apparatus in which an end of a tape accommodated in a tape cassette has a coupling element, the coupling element comprises a shaft portion and enlarged portions formed on opposite ends of the shaft portion, and the coupling element is mounted at the time of a tape threading operation during which the coupling element is pulled out and the tape is taken up around a drive reel, wherein the tape-pulling-out element includes a first member formed with a recess, and a second member connected to the first member such that the second member can be displaced, and at least the opposite ends of the shaft portion are covered with the recess and the second member.

According to a ninth aspect of the invention, in the eighth aspect, the first member is provided at its one end with a turn shaft which turns the second member, and the first member is provided at its other end with the recess.

According to a tenth aspect of the invention, in the eighth aspect, the recess of the first member is opened by pressing the second member on the side of the turn shaft.

According to the present invention, it is possible to reliably hold a coupling element and to stably carry out a tape threading operation.

### BRIEF DESCRIPTION OF THE DRAWINGS

FIG. 1 is a plan view of an essential portion of a magnetic recording/reproducing apparatus according to an embodiment of the present invention;

FIG. 2 is a plan view of an essential portion of the apparatus;

FIG. 3 is a plan view of the essential portion of the apparatus;

FIG. 4 is a plan view of the essential portion of the apparatus;

FIG. 5 is a plan view of the essential portion of the apparatus;

FIG. 6 is a plan view of the essential portion of the apparatus;

FIG. 7 is a plan view of the essential portion of the apparatus;

FIG. 8 is a plan view of the essential portion of the apparatus;

FIG. 9 is a perspective view of a tape-pulling-out element of the embodiment;

FIG. 10 is a perspective view showing a state where a recess in FIG. 9 is opened;

FIG. 11 is a perspective view showing a state where a coupling element is mounted on the recess in FIG. 9;

FIG. 12 is a perspective view showing a state where the coupling element is abutted against the recess in FIG. 10;

FIG. 13 is a perspective view of FIG. 11 as viewed from a different angle; and

FIG. 14 is a perspective view of FIG. 12 as viewed from a different angle.

### BEST MODE FOR CARRYING OUT THE INVENTION

The magnetic recording/reproducing apparatus of the first aspect of the present invention comprises a leader tape having one end connected to the drive reel, a tape-pulling-out element connected to the other end of the leader tape, a pulling-out element moving motor for moving the tape-pulling-out element into the tape cassette, and the tape-pulling-out element includes a first member formed with a recess, and a second member connected to the first member such that the second member can be displaced, and the coupling element is mounted on the tape-pulling-out element by the recess and the second member. According to this aspect, since the coupling element is mounted on the tape-pulling-out element by the first member formed with the recess and the second member connected to the first member such that the second member can displace, the coupling element can be held by sandwiching the same by the two members, and the coupling element can reliably be mounted on the tape-pulling-out element.

According to the second aspect of the invention, in the magnetic recording/reproducing apparatus of the first aspect, the coupling element comprises a shaft portion and enlarged portions formed on opposite ends of the shaft portion, and at least the opposite ends of the shaft portion are covered with the recess and the second member. According to this aspect, since both ends of the coupling element are held, the coupling element is not inclined especially, and the coupling element can be held stably.

According to the third aspect of the invention, in the magnetic recording/reproducing apparatus of the first aspect, the second member is formed with a recess, and the coupling element is mounted between the recess of the first member and the recess of the second member. According to this aspect, the coupling element is mounted between the recesses of both the members, and the coupling element can be held stably.

According to the fourth aspect of the invention, in the magnetic recording/reproducing apparatus of the first aspect, the first member is provided at its one end with a turn shaft which turns the second member, and the first member is provided at its other end with the recess. According to this aspect, the turning shaft of the second member is provided on the one end side of the first member. With this, the moving range of the second member on the other end side of the first member can be increased, and the attaching and detaching operation can be carried out reliably.

According to the fifth aspect of the invention, in the magnetic recording/reproducing apparatus of the fourth aspect, magnetic recording/reproducing apparatus further comprises a track groove for guiding the tape-pulling-out element to the drive reel, and an end of the turn shaft slides in the track groove. According to this aspect, the turning shaft of the second member with respect to the first member can be utilized as a sliding member of the track groove. With this, the number of constituent parts of the tape-pulling-out element can be reduced, and even if the tape-pulling-out element is reduced in size, the coupling element can be stably held.

According to the sixth aspect of the invention, in the magnetic recording/reproducing apparatus of the fourth aspect, the recess of the first member is opened by pressing the second member on the side of the turn shaft. According to this aspect, since the first member is opened and closed by the operation on the side of the turning shaft, the moving space on the side of the recess can sufficiently be secured.

According to the seventh aspect of the invention, in the magnetic recording/reproducing apparatus of the fifth aspect, the magnetic recording/reproducing apparatus further comprises a tape-pulling-out element moving member which holds the tape-pulling-out element and which is moved by rotation of the pulling-out element moving motor, and the tape-pulling-out element moving member includes a turning shaft recess with which the turn shaft is engaged, and the turning shaft recess is disposed at a position where the turning shaft recess is continuous with the track groove when take-up operation by the drive reel is started. According to this aspect, the turning shaft recess with which the turning shaft is engaged and the track groove can be connected to each other. With this, the tape-pulling-out element can easily be moved, and the tape threading operation can be carried out with a simple structure.

In the tape-pulling-out element of the magnetic recording/reproducing apparatus according to the eighth aspect of the invention, the tape-pulling-out element includes a first member formed with a recess, and a second member connected to the first member such that the second member can be displaced, and at least the opposite ends of the shaft portion are covered with the recess and the second member. According to this aspect, the coupling element can be held by sandwiching operation of the two members in the both ends of the coupling element, and the coupling element can be held stably.

According to the ninth aspect of the invention, in the tape-pulling-out element of a magnetic recording/reproducing apparatus of the eighth aspect, the first member is provided at its one end with a turn shaft which turns the second member, and the first member is provided at its other end with the recess. According to this aspect, since the turning shaft of the second member is provided on the side of one end of the first member, the moving range of the second member on the side of the other end of the first member can be increased, and the attaching and detaching operation can be carried out reliably.

According to the tenth aspect of the invention, in the tape-pulling-out element of a magnetic recording/reproducing apparatus of the eighth aspect, the recess of the first member is opened by pressing the second member on the side of the turn shaft. According to this aspect, the opening and closing operation of the first member is carried out by the operation on the side of the turning shaft, and the moving space on the side of the recess can sufficiently be secured.

A magnetic recording/reproducing apparatus of an embodiment of the present invention will be explained below.

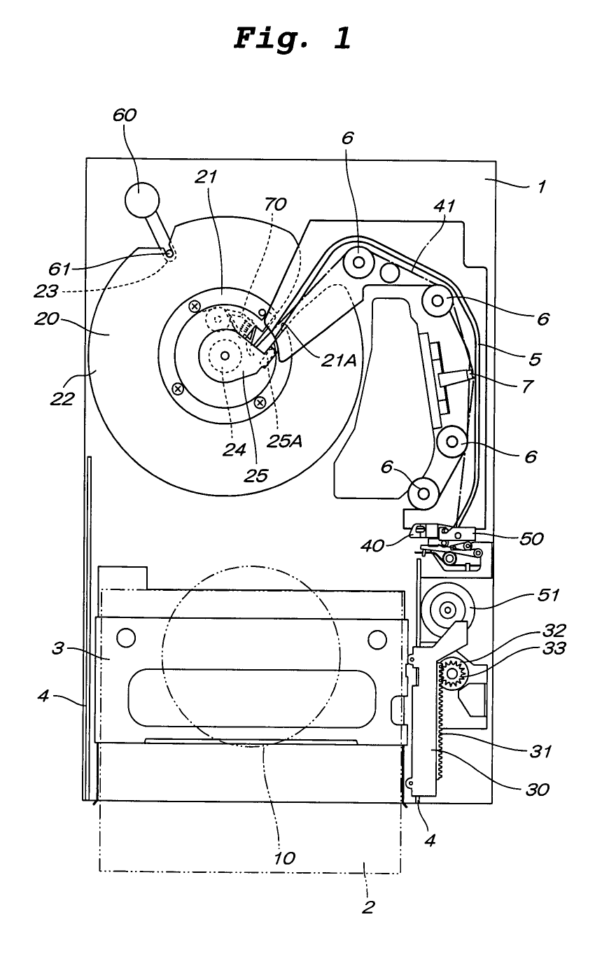

FIG. 1 is a plan view of an essential portion of the magnetic recording/reproducing apparatus of the embodiment.

A base 1 of an apparatus main body includes a cartridge reel 10 having rotating means such as a motor, and a drive reel 20 having another rotating means. A cassette holder 3 which holds the tape cassette 2 and which moves the tape cassette 2 is provided on the side of the cartridge reel 10 of the base 1. A pair of rails 4 is disposed on the side of the cartridge reel 10 of the base 1, and the cassette holder 3 is provided such that the cassette holder 3 can slide along the pair of rails 4.

A loading lever 30 is slidably provided on one of the rails 4. The loading lever 30 is connected to the cassette holder 3, and the cassette holder 3 is operated by movement of the loading lever 30.

A rack 31 is connected to a surface of the loading lever 30 on the side of the base 1. A loading motor 32 and a gear 33 connected to the loading motor 32 are disposed on the side of the loading lever 30. The rack 31 and the gear 33 mesh with each other, and the loading lever 30 slides along the rails 4 by rotation of the loading motor 32.

A tape-pulling-out element 40 is disposed on the side of the tape cassette 2, that is, disposed in the vicinity of a door (not shown) of the tape cassette 2, when the loading operation is completed. The tape-pulling-out element 40 is held by a tape-pulling-out element moving member 50. The tape-pulling-out element moving member 50 is engaged with a groove (not shown) provided in a direction moving toward and away from a door of the tape cassette 2. A tape-pulling-out element moving motor 51 is disposed in a space between the loading motor 32 and the tape-pulling-out element 40 on the side of the loading lever 30. The tape-pulling-out element moving member 50 is connected to the tape-pulling-out element moving motor 51 through a gear mechanism (not shown).

Track grooves 5 are formed between positions in the vicinity of the tape-pulling-out element 40 and a reel hub 21 of a drive reel 20. Although only the track groove 5 on the side of the base 1 is shown in FIG. 1, another track groove having the same shape is also formed in a member (not shown) disposed at a predetermined distance from the former track groove 5, and the tape-pulling-out element 40 is guided by the pair of track grooves 5. A plurality of rollers 6 and a magnetic head 7 are disposed on the side of the track groove 5. In a state shown in the drawing, a reader tape 41 is disposed along the track groove 5. One end of the reader tape 41 is connected to the Drive reel 20, and the other end of the reader tape 41 is connected to the tape-pulling-out element 40.

The drive reel 20 includes a reel flange 22. The reel flange 22 is formed at its outer peripheral end with a flange groove 23. Although only the reel flange 22 on the side of the base 1 is shown in the drawing, a pair of reel flanges 22 is connected to both end surfaces of the reel hub 21. A hub opening 21A is formed in a portion of an outer periphery of the reel hub 21, and the reader tape 41 passes through the hub opening 21A. The tape-pulling-out element 40 is fitted into the hub opening 21A. The drive reel 20 is provided at its center with a drive shaft 24 which transmits rotation of the rotating means such as the motor. The connection of the drive shaft 24 with respect to the reel hub 21 and the reel flange 22 is released by the lock member 70 at the time of tape threading motion, and drive shaft 24 is connected to the reel hub 21 and the reel flange 22 at the time of recording and replaying operations. The reel hub 21 is provided at its end surface with a magnet holding member 25. A magnet 25A is disposed in the vicinity of the hub opening 21A in the reel hub 21 by this magnet holding member 25.

A lock motor 60 and a pin 61 which moves into the flange groove 23 by the rotation of the lock motor 60 are disposed on the side of the outer periphery of the reel flange 22 on the side of the base 1.

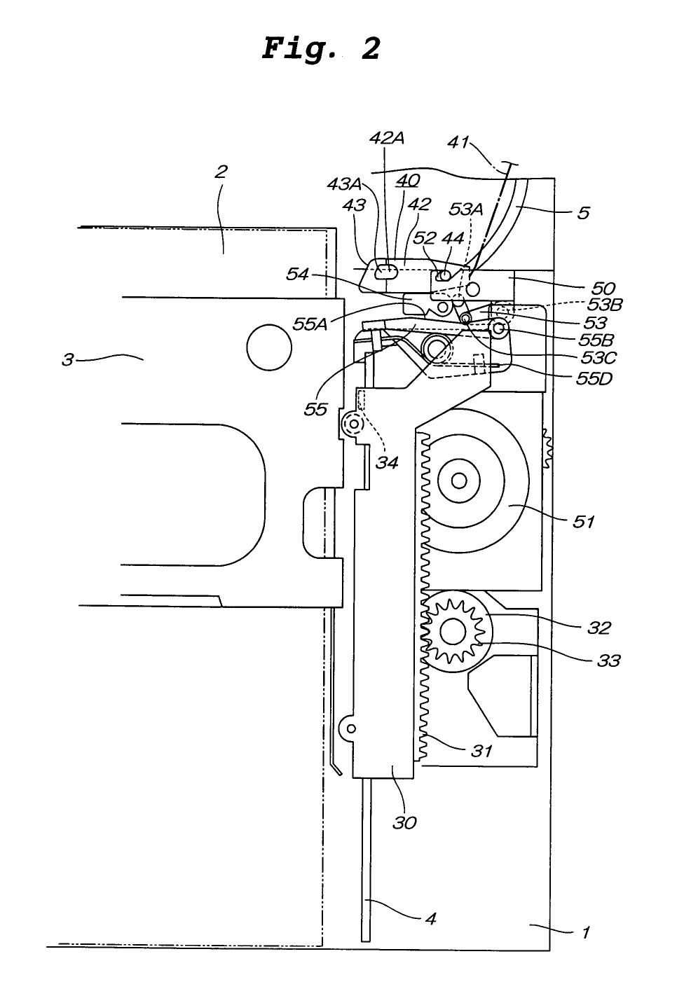

Next, a structure around the tape-pulling-out element moving member 50 will be explained in detail using FIG. 2.

First, the tape-pulling-out element 40 includes a first member 42 forming a recess 42A, and a second member 43 connected to the first member 42 such that the second member 43 can be displaced. The first member 42 is provided at its one end with a turning shaft 44 which turns the second member 43. The recess 42A is formed in the other end of the first member 42. Both ends of the turning shaft 44 project into the track grooves 5, so that the turning shaft 44 can slide along the track grooves 5. The second member 43 is formed with a recess 43A, and the recess 42A of the first member 42 and the recess 43A of the second member 43 form a closed space.

The tape-pulling-out element moving member 50 includes a turning shaft recess 52 with which the turning shaft 44 is engaged. The turning shaft recess 52 is continuous with an end of the track groove 5 at a predetermined position of the tape-pulling-out element moving member 50. The tape-pulling-out element moving member 50 includes a press member 53 and a support member 54. The press member 53 is provided at its one end with a press rib 53A which presses the second member 43 on the side of the turning shaft 44, and at its other end with a shaft 53B which functions as a turning fulcrum of the press rib 53A, and at its intermediate portion with a roller pin 53C. The support member 54 supports the first member 42, and prevents the tape-pulling-out element 40 from rotating when the second member 43 on the side of the turning shaft 44 is pressed by the press rib 53A. The support member 54 is provided at its lower surface with a pin, and if the pin slides in the groove, this exhibits a guide function when the tape-pulling-out element moving member 50 moves toward and away from the tape cassette 2. At a position where the tape-pulling-out element moving member 50 is most separated from the tape cassette 2, the support member 54 turns in the counterclockwise direction through a predetermined angle, thereby turning the tape-pulling-out element 40 in the counterclockwise direction. Thus, the support member 54 moves the tape-pulling-out element 40 into the groove 5 smoothly.

A guider 55 is disposed between the tape-pulling-out element moving member 50 and the loading lever 30. The guider 55 is formed with a guide surface 55A formed on its side on the side of the tape-pulling-out element moving member 50. The guide surface 55A limits movement of the roller pin 53C. The guider 55 can turn through a predetermined angle around the rotation shaft 55B. The guider 55 is biased toward the loading lever 30 by the elastic member 55D.

The loading lever 30 is provided at its end on the side of the guider 55 with a press member 34. The press member 34 presses the elastic member 55D by moving the loading lever 30 toward the tape-pulling-out element moving member 50. If the elastic member 55D is pressed by the press member 34, a free end of the guider 55 moves toward the tape-pulling-out element moving member 50.

The tape threading motion will be explained using FIGS. 1 to 8.

FIG. 1 shows a state of the tape cassette 2 before loading.

If this apparatus detects the insertion of the tape cassette 2 into the cassette holder 3, the loading motor 32 starts rotating. The rotation of the loading motor 32 is transmitted to the loading lever 30 by the gear 33 and the rack 31, and the loading lever 30 moves toward the tape-pulling-out element 40. The cassette holder 3 moves together with the loading lever 30. If the tape cassette 2 moves to a position above the cartridge reel 10, a portion of the cassette holder 3 moves the tape cassette 2 toward the base 1, and drive teeth (not shown) provided on a back surface of the tape cassette 2 are engaged with the cartridge reel 10.

By engaging the tape cassette 2 with the cartridge reel 10, the loading motion is completed. FIG. 2 shows a position of the loading lever 30 in this state. In a state where the loading of the tape cassette 2 is completed, the door of the tape cassette 2 is opened. The end of the tape accommodated in the tape cassette 2 is provided with the connection element (not shown), and this connection element is guided to a location near the door.

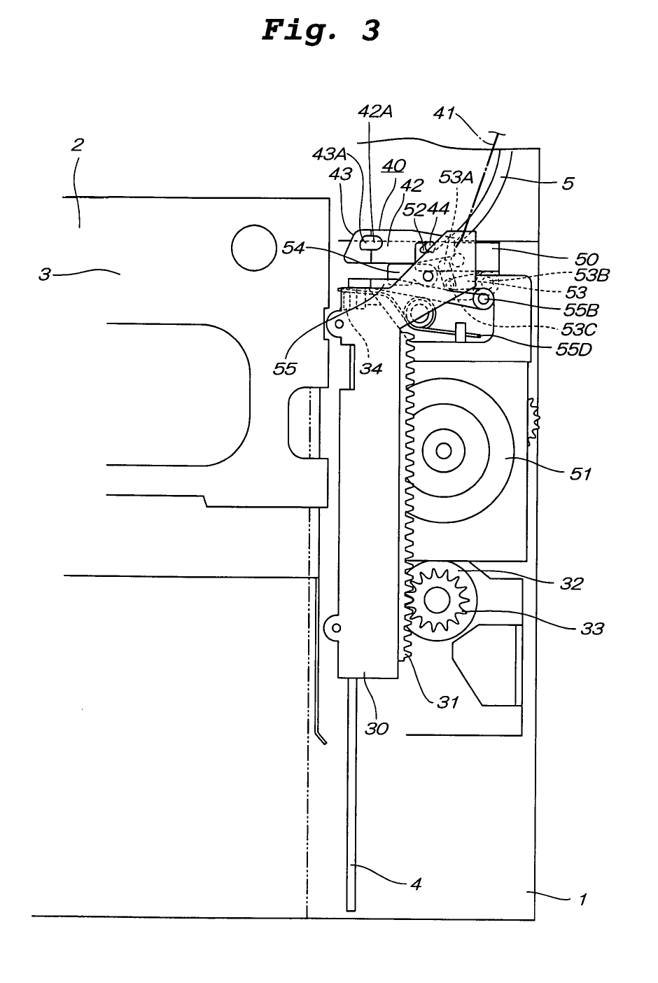

The loading lever 30 is moved to a location shown in FIG. 3 from the state shown in FIG. 2 which shows the state where the loading operation of the tape cassette 2 is completed. The loading motor 32 moves the loading lever 30 to the position shown in FIG. 3 and is stopped.

In the state shown in FIG. 3, the press member 34 of the loading lever 30 pushes the elastic member 55D, and a free end of the guider 55 is moved toward the tape-pulling-out element moving member 50. If the guider 55 moves, the position of the roller pin 53C is limited by the guide surface 55A.

The tape-pulling-out element moving motor 51 starts driving from the state shown in FIG. 3. If the tape-pulling-out element moving motor 51 is driven, the tape-pulling-out element moving member 50 is moved toward the tape cassette 2.

If the tape-pulling-out element moving member 50 is moved, the roller pin 53C is moved along the guide surface 55A. As the roller pin 53C approaches the tape cassette 2, the guide surface 55A approaches the tape-pulling-out element moving member 50 and thus, the roller pin 53C approaches the tape-pulling-out element moving member 50. If the roller pin 53C is displaced, the press rib 53A moves toward the tape-pulling-out element 40. The press rib 53A presses the side of the second member 43. If the press rib 53A presses the second member 43, the second member 43 turns around the turning shaft 44. The recess 43A of the second member 43 moves away from the recess 42A of the first member 42 and the recess 42A is opened.

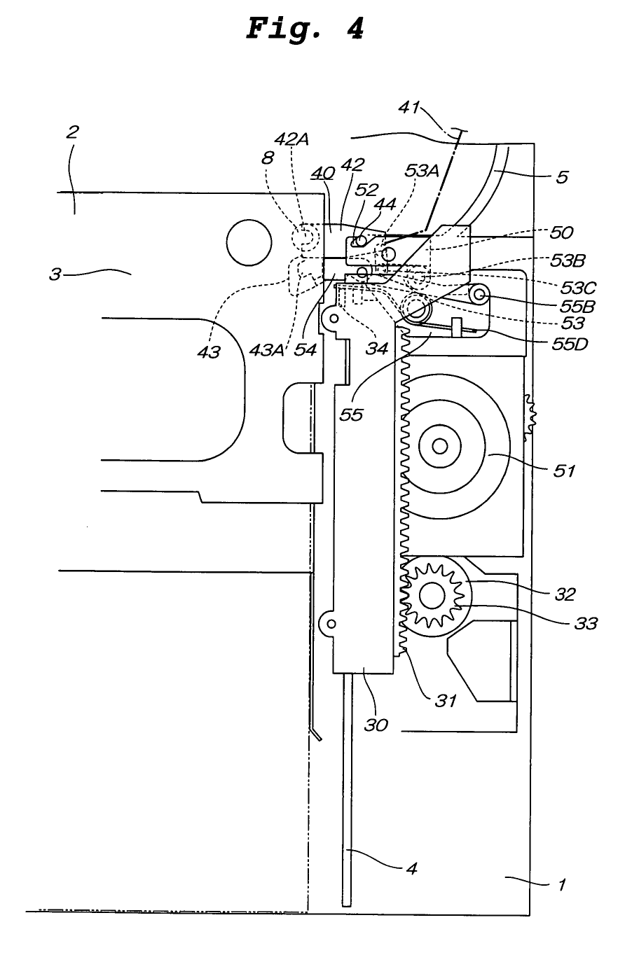

The tape-pulling-out element moving motor 51 moves the tape-pulling-out element moving member 50 and stops until the recess 42A of the first member 42 of the tape-pulling-out element 40 is inserted into the cassette 2. FIG. 4 shows this state.

In the state shown in FIG. 4, the recess 42A of the first member 42 is abutted against the connection element 8.

From the state shown in FIG. 4, the loading motor 32 is driven by reverse rotation, and the loading lever 30 is retreated. If the loading lever 30 is retreated, the pressing force of the press member 34 of the loading lever 30 against the guider 55 is released. Therefore, since the free end of the guider 55 moves toward the loading lever 30, the pressing force of the press rib 53A against the second member 43 is released. Since the pressing force of the press rib 53A against the second member 43 is released, the second member 43 turns around the turning shaft 44, the recess 43A of the second member 43 approaches the recess 42A of the first member 42 and the recess 42A is closed. Next, the tape-pulling-out element moving motor 51 starts driving by reverse rotation. By reversely rotating the tape-pulling-out element moving motor 51, the tape-pulling-out element moving member 50 starts moving away from the tape cassette 2.

Therefore, the connection element 8 is disposed in a closed space formed by the recess 42A of the first member 42 and the recess 43A of the second member 43. That is, the connection element 8 is sandwiched and held between the recess 42A of the first member 42 and the recess 43A of the second member 43. FIG. 5 shows this state.

From the state shown in FIG. 5, the tape-pulling-out element moving motor 51 keeps driving by the reverse rotation. If the tape-pulling-out element moving motor 51 keeps driving by the reverse rotation, the tape-pulling-out element moving member 50 further moves away from the tape cassette 2.

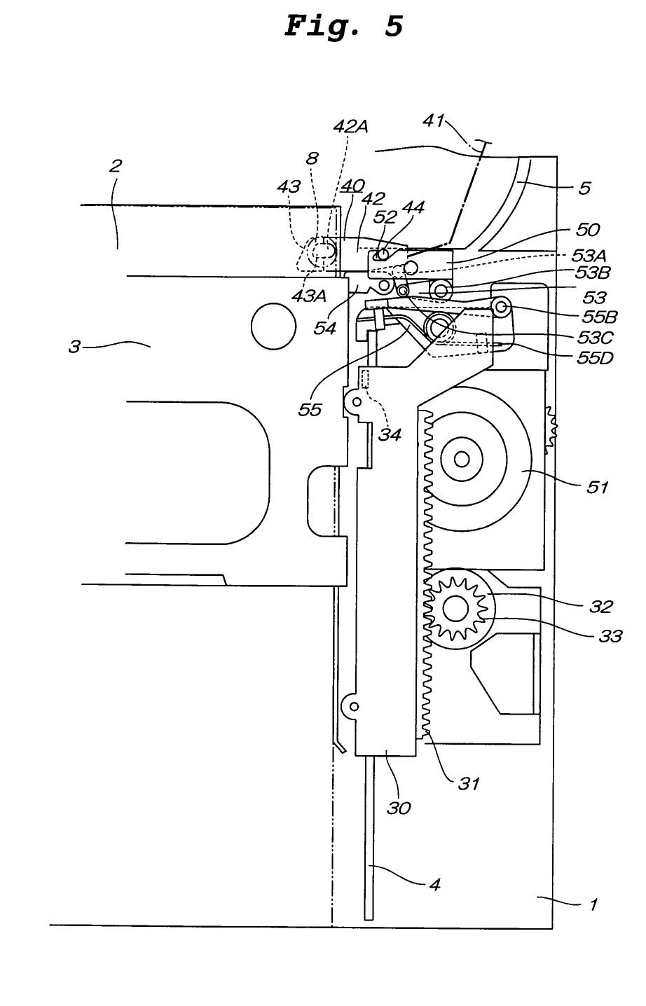

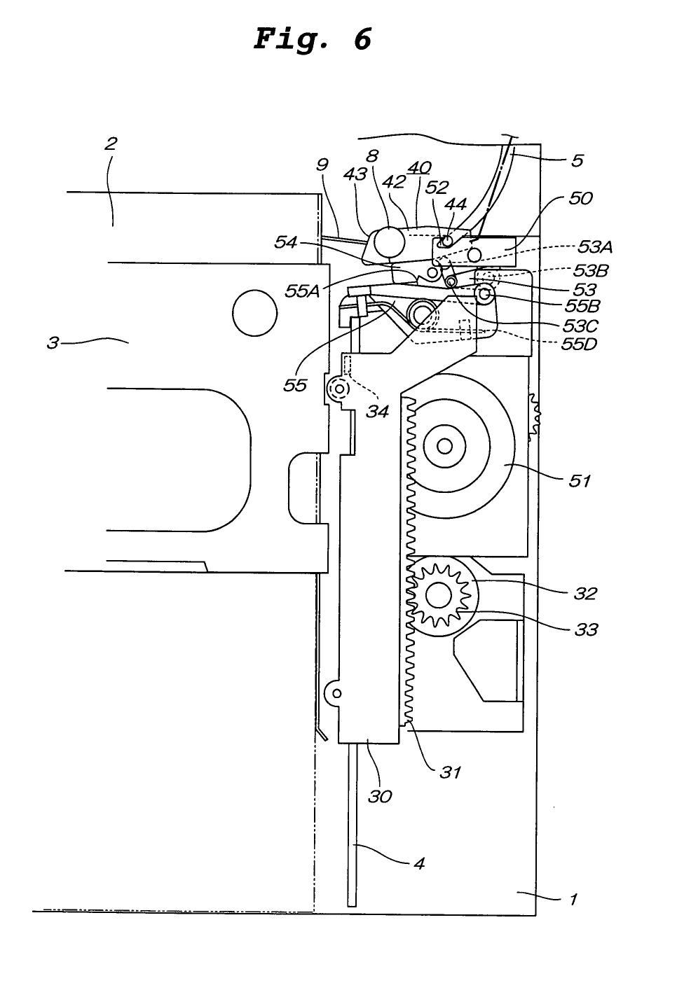

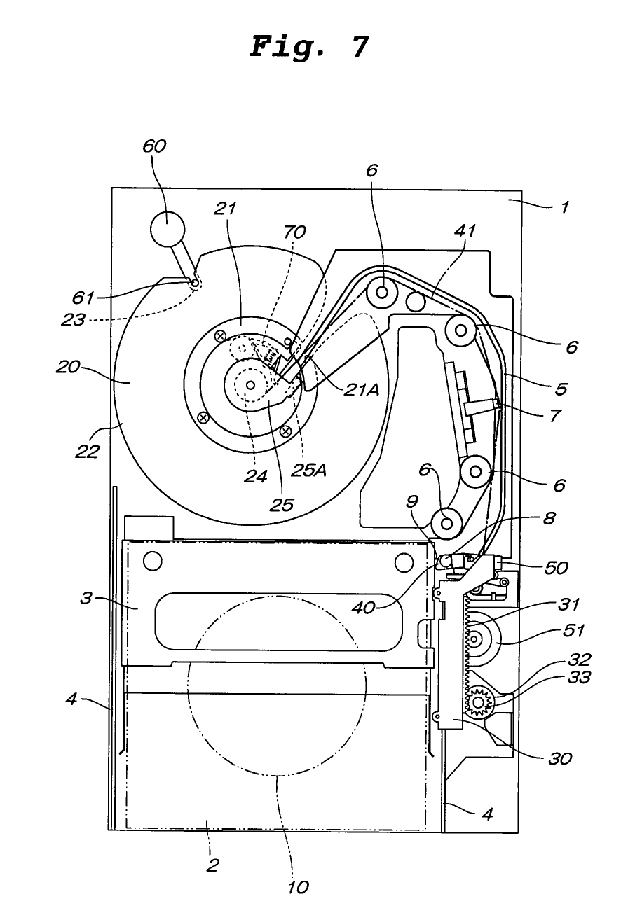

FIGS. 6 and 7 show a state where the movement of the tape-pulling-out element moving member 50 away from the tape cassette 2 is completed. As shown in FIG. 6, a tape 9 accommodated in the tape cassette 2 is pulled out together with the connection element 8. In a state where the movement of the tape-pulling-out element moving member 50 away from the tape cassette 2 is completed, the turning shaft recess 52 is in a position continuous with the end of the track groove 5. In this position, the support member 54 is turned in the counterclockwise direction through a predetermined angle, thereby turning the tape-pulling-out element 40 in the counterclockwise direction, and the tape-pulling-out element 40 smoothly moves toward the groove 5.

From the state shown in FIGS. 6 and 7, the tape threading motion is started.

The tape threading motion is carried out by rotating the drive reel 20. At the time of the tape threading motion, the reel hub 21 is released from a drive system of the drive reel 20, and rotation of the reel hub 21 is limited by the pin 61.

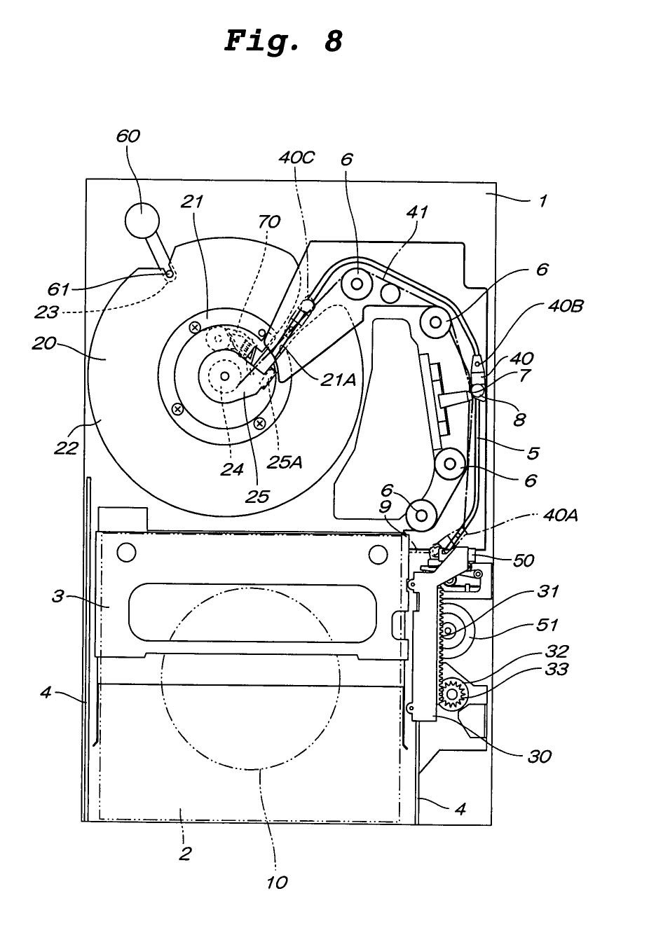

The reader tape 41 is reeled up around the drive shaft of the drive reel 20 by the rotation of the drive reel 20. By the reeling up motion of the reader tape 41 around the drive shaft of the drive reel 20, the tape-pulling-out element 40 is pulled by the reader tape 41. Therefore, the both ends of the turning shaft 44 of the tape-pulling-out element 40 move toward the track grooves 5 from the turning shaft recess 52, and slide in the track grooves 5. FIG. 8 shows this state.

FIG. 8 shows a state where the turning shaft 44 of a tape-pulling-out element 40A moves from the turning shaft recess 52 to the track groove 5, a tape-pulling-out element 40B moves to an intermediate portion of the track groove 5, and a tape-pulling-out element 40C moves to a location close to the reel hub 21 of the drive reel 20. By sequentially moving the tape-pulling-out element like the tape-pulling-out element 40A, the tape-pulling-out element 40B and the tape-pulling-out element 40C, the tape 9 accommodated in the tape cassette 2 can be pulled out and introduced to the reel hub 21.

If the reader tape 41 is reeled up into the reel hub 21, the tape-pulling-out element 40 is pulled into the hub opening 21A. The tape-pulling-out element 40 pulled into the hub opening 21A is attracted by the magnet 25A, thereby completing the reeling up operation of the reader tape 41. In this state, the tape-pulling-out element 40 closes the hub opening 21A, and a terminate end surface of the tape-pulling-out element 40, i.e., an end surface on the mounting side of the connection element 8 is disposed such as to be continuous with the outer peripheral surface of the reel hub 21.

The above-described motion is carried out by normally rotating the drive shaft 24, but if it is detected that the tape-pulling-out element 40 closes the hub opening 21A, the rotation of the drive shaft 24 is stopped. By reversely rotating the drive shaft 24 through a predetermined angle, the lock member 70 is operated and the drive shaft 24 is connected to the reel hub 21 and the reel flange 22.

If the drive shaft 24 is connected to the reel hub 21 and the reel flange 22, the lock motor 60 is operated and the pin 61 is retreated from the flange groove 22.

With this above motion, the tape threading motion is completed.

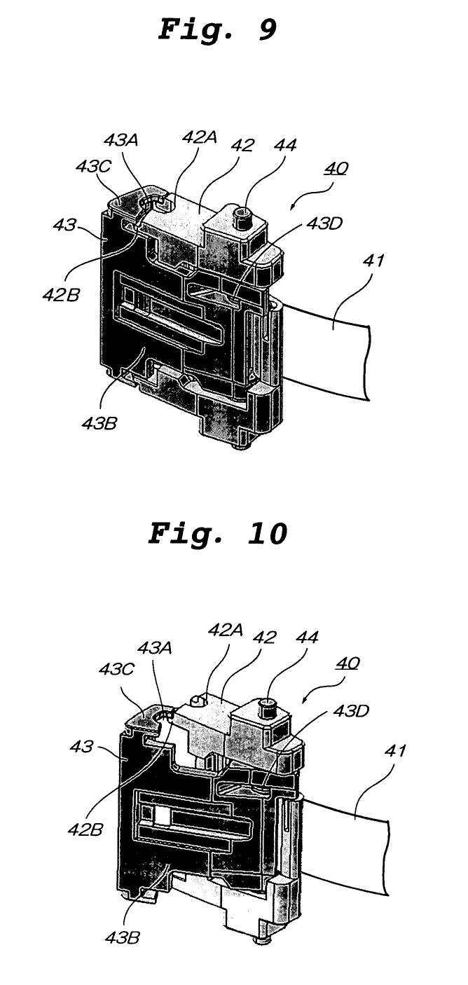

Next, the tape-pulling-out element of the embodiment will be explained using FIGS. 9 to 14.

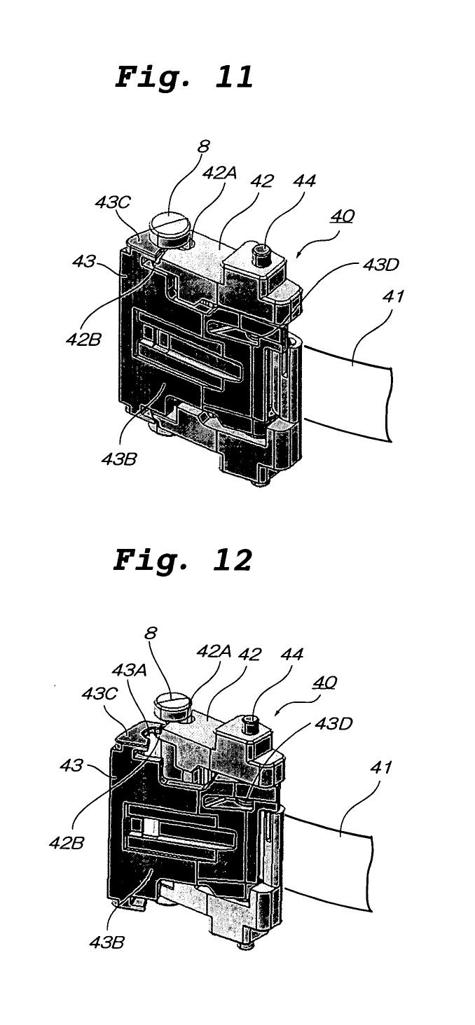

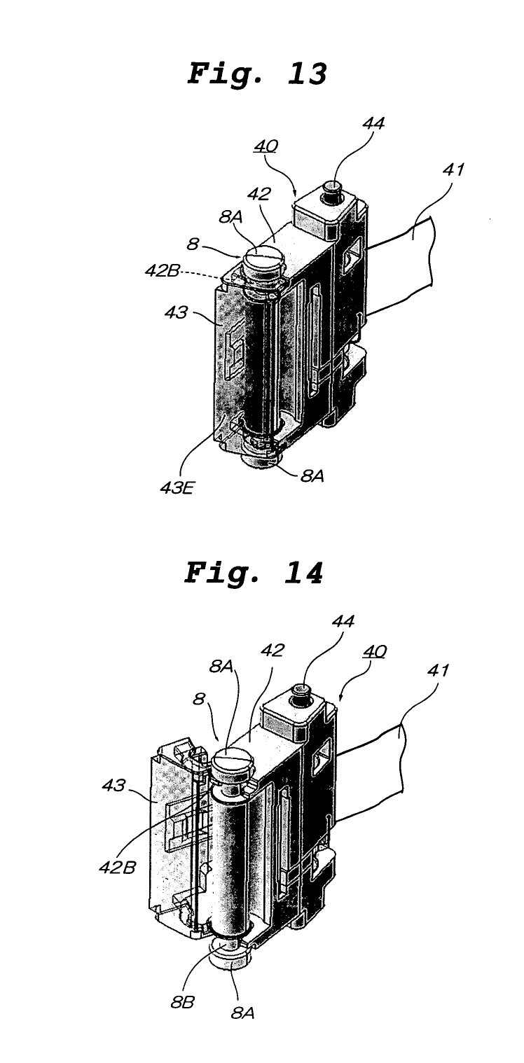

FIG. 9 is a perspective view of a tape-pulling-out element of the embodiment. FIG. 10 is a perspective view showing a state where a recess in FIG. 9 is opened. FIG. 11 is a perspective view showing a state where a coupling element is mounted on the recess in FIG. 9. FIG. 12 is a perspective view showing a state where the coupling element is abutted against the recess in FIG. 10. FIG. 13 is a perspective view of FIG. 11 as viewed from a different angle. FIG. 14 is a perspective view of FIG. 12 as viewed from a different angle.

The first member 42 constituting the tape-pulling-out element 40 is provided at its one end with the turning shaft 44 which turns the second member 43, and at its other end with a pair of recesses 42A. A space in which a shaft of the coupling element 8 is disposed is formed between the pair of recesses 42A.

The second member 43 constituting the tape-pulling-out element 40 has a substrate 43B provided on one side of the first member 42. One end of the substrate 43B is provided on the turning shaft 44 such that the substrate 43B can turn through a predetermined angle. The other end of the substrate 43B includes a lid plate 43C extending at a predetermined angle with respect to the substrate 43B. The lid plate 43C forms a recess 43A on the side of the first member 42 (inner peripheral side) and forms a curved surface 43E on the opposite side (outer peripheral side) from the first member 42. The curved surface 43E has the same curvature as that of the outer peripheral surface of the reel hub 21, and in a state where the tape-pulling-out element 40 is fitted into the hub opening 21A, the curved surface 43E constitutes a portion of the outer peripheral surface of the reel hub 21. A resilient member 43D is provided on the side of the turning shaft 44 of the substrate 43B. The resilient member 43D biases the second member 43 in a direction in which the lid plate 43C closes the recess 42A of the first member 42.

The shaft 8B of the coupling element 8 is provided at its both ends with enlarged portions 8A. The recess 42A and the recess 43A sandwich the shaft 8B such that the enlarged portions 8A are located outward, thereby holding the coupling element 8. The tape-pulling-out element 40 holds the pulling-out element 8 irrespective of from which direction the coupling element 8 is pulled. That is, the coupling element 8 tape threads while always being pulled toward the curved surface 43E, and the coupling element 8 is normally pressed against the recess 43A. When an external force toward the substrate 43B is applied to the coupling element 8, since the coupling element 8 is held by the rib 42B provided on a lower portion of the recess 42A, the second member 43 does not open as shown in FIGS. 12 and 14. Here, the rib 42B projects toward the recess 43A at a location lower than the recess 42A by one step so that the rib 42B and the recess 43A are superposed on each other. When an external force in the opposite direction from the substrate 43B is applied to the coupling element 8, since this direction is a closing direction of the second member 43, the coupling element 8 is held. When an external force in the direction of the rotation shaft 44 is applied to the coupling element 8, the coupling element 8 is held in the recess 42A.

According to the embodiment, since the coupling element 8 is mounted on the tape-pulling-out element 40 by the first member 42 formed with the recess 42A and the second member 43 which is connected to the first member 42 such that the second member 43 can displace with respect to the first member 42, the coupling element 8 can be held by sandwiching the coupling element by the two members, and the coupling element 8 can reliably be mounted on the tape-pulling-out element 40.

According to the embodiment, since the both ends of the shaft 8B of the coupling element 8 are covered with the recess 42A and the second member 43, the coupling element 8 is not inclined, and the coupling element 8 can be held stably.

According to the embodiment, since the coupling element 8 is mounted between the recess 42A of the first member 42 and the recess 43A of the second member 43, the outer periphery of the coupling element 8 can be covered with both the members, and the coupling element 8 can be held stably.

According to the embodiment, since the turning shaft 44 of the second member 43 is provided on the one end of the first member 42, the moving range of the second member 43 on the other end side of the first member 42 can be increased, and the attaching and detaching operation can be carried out reliably.

According to the embodiment, the turning shaft 44 of the second member 43 with respect to the first member 42 is utilized as a sliding member of the track groove 5, the number of constituent parts of the tape-pulling-out element can be reduced, and even when the tape-pulling-out element is reduced in size, the coupling element can be held stably.

According to the embodiment, the first member 42 can be opened and closed by pressing the turning shaft 44 of the second member 43. Therefore, a moving space on the side of the recess 42A can sufficiently be secured.

According to the embodiment, the turning shaft recess 52 is disposed at a position where the turning shaft recess 52 is continuous with the track groove 5, and the turning shaft recess 52 with which the turning shaft 44 is engaged and the track groove 5 can be connected to each other. With this, the tape-pulling-out element 40 can move easily, and the tape threading can be carried out with a simple structure.

The magnetic recording/reproducing apparatus and the tape-pulling-out element of this invention are suitable for an apparatus such as a linear type open system, and such apparatus is especially useful as a network tape storage.

1. A magnetic recording/reproducing apparatus in which an end of a tape accommodated in a tape cassette has a coupling element, said coupling element is pulled out and said tape is taken up around a drive reel, said magnetic recording/reproducing apparatus comprising
a leader tape having one end connected to said drive reel,
a tape-pulling-out element connected to the other end of said leader tape, and
a pulling-out element moving motor for moving said tape-pulling-out element into said tape cassette, wherein
said tape-pulling-out element includes a first member formed with a recess, and a second member connected to said first member such that said second member can be displaced, and
said coupling element is mounted on said tape-pulling-out element by said recess and said second member.

2. The magnetic recording/reproducing apparatus according to claim 1, wherein
said coupling element comprises a shaft portion and enlarged portions formed on opposite ends of said shaft portion, and at least the opposite ends of said shaft portion are covered with said recess and said second member.

3. The magnetic recording/reproducing apparatus according to claim 1, wherein
said second member is formed with a recess, and said coupling element is mounted between said recess of said first member and said recess of said second member.

4. The magnetic recording/reproducing apparatus according to claim 1, wherein
said first member is provided at its one end with a turn shaft which turns said second member, and said first member is provided at its other end with said recess.

5. The magnetic recording/reproducing apparatus according to claim 4, further comprising a track groove for guiding said tape-pulling-out element to said drive reel, wherein
an end of said turn shaft slides in said track groove.

6. The magnetic recording/reproducing apparatus according to claim 4, wherein
said recess of said first member is opened by pressing said second member on the side of said turn shaft.

7. The magnetic recording/reproducing apparatus according to claim 5, further comprising a tape-pulling-out element moving member which holds said tape-pulling-out element and which is moved by rotation of said pulling-out element moving motor, wherein
said tape-pulling-out element moving member includes a turning shaft recess with which said turn shaft is engaged, and said turning shaft recess is disposed at a position where said turning shaft recess is continuous with said track groove when take-up operation by said drive reel is started.

8. A tape-pulling-out element of a magnetic recording/reproducing apparatus in which an end of a tape accommodated in a tape cassette has a coupling element, said coupling element comprises a shaft portion and enlarged portions formed on opposite ends of said shaft portion, and said coupling element is mounted at the time of a tape threading operation during which said coupling element is pulled out and said tape is taken up around a drive reel, wherein
said tape-pulling-out element includes a first member formed with a recess, and a second member connected to said first member such that said second member can be displaced, and
at least the opposite ends of said shaft portion are covered with said recess and said second member.

9. The tape-pulling-out element of the magnetic recording/reproducing apparatus according to claim 8, wherein
said first member is provided at its one end with a turn shaft which turns said second member, and said first member is provided at its other end with said recess.

10. The tape-pulling-out element of the magnetic recording/reproducing apparatus according to claim 8, wherein
said recess of said first member is opened by pressing said second member on the side of said turn shaft.
